(19) United States
(12) Patent Application Publication
(10) Pub. No.: US 2015/0197418 A1
(43) Pub. Date: Jul. 16, 2015

(54) WOOL MIXTURE FILL MATERIAL

(71) Applicant: Brian Parnes, Cincinnati, OH (US)

(72) Inventor: Brian Parnes, Cincinnati, OH (US)

(21) Appl. No.: 14/591,632

(22) Filed: Jan. 7, 2015

Related U.S. Application Data
(60) Provisional application No. 61/924,469, filed on Jan. 7, 2014.

(51) Int. Cl. B68G 1/00; D04H 1/4266

(52) U.S. Cl. CPC B68G 1/00; D04H 1/4266

(57) ABSTRACT

A fill material for use with pillows, comforters and other products includes a mixture of wool fiber clusters and a secondary fill material, such as down. The fill material has various advantageous characteristics such as improved washability and improved breathability while maintaining softness, comfort, and thermal characteristics.

This application claims priority to U.S. application Ser. No. 61/924,469 filed Jan. 7, 2014, which is expressly incorporated by reference herein in its entirety.

This present composition relates to a fill material, which can be used in a variety of formats, including bedding, such as comforters, outerwear, such as jackets and coats, and in general, as a substitute fill material in any application where down or wool is typically used. More particularly, the fill material comprises a wool mixture, and in one embodiment, comprises a wool/down mixture. In various embodiments, the described wool mixture provides optimal insulation while increasing breathability, washability, and providing a desired “hand feel” of the fill material.

In one aspect, the fill material comprises a wool, wherein the wool fibers are converted into knops, also referred to as clusters, in a process called clusterization. Knops are tightly processed clusters, and in one embodiment, the clusters range in size from about 0.5 mm to about 20 mm. Without being held to a single theory, the described wool fiber clusters provide advantageous benefits to both the feel of the end product and its properties. For instance, the wool fiber clusters allow for added support and resiliency versus non-clustered fiber, and are much more durable. In one embodiment, clusterization involves separating individual filaments from each other by a flow of gas which is blown into a vessel with perforated walls and containing the fibers. The fibers are rotated by eccentrically blowing in a flow of gas into a vessel while forming a spherical molded fiber aggregate. Due to the mutual fastening (fusion) of the filaments at their points of contact, these aggregates do not generally hook into or penetrate each other. These fiber aggregates exhibit properties that are similar to down with respect to their great bulk, compressive elasticity, softness, thermal insulating characteristics, light weight and good adaptation to the body to be covered. Although the wool fiber aggregates are generally spherical, they may have other configurations, such as ovaloid.

In various embodiments, it is desirable that the resultant wool clusters are devoid, or substantially devoid, of individual fibers protruding from the cluster. In one embodiment, the wool clusters are formed using a clusterizing machine, as is known in the art. In addition, the parameters of the clusterizing machine can be varied as desired, such as to produce clusters substantially devoid of protruding fibers, for example, by varying the amount of time the wool is in the machine and/or how much wool is loaded into the machine. Without being held to a single theory, the present inventors have found that having fiber ends protruding from the clusters hinders washability, such as in a wool/down combination, described below, thereby creating an inferior product. In addition, these fibers protruding from the wool cluster will ultimately destroy the down or other fiber in the described mixture, causing it to rapidly degrade over time. Thus, an object of the described mixture is to minimize entanglement of the wool and a secondary fill material described below.

In an alternate embodiment, the wool is not formed into clusters, but instead, the wool is processed into short-staple fibers, having a length of about 3 mm to about 64 mm in cut length, which are then subjected to an opening process to “fluff up” the wool before used as described herein. In one embodiment, the opening process uses an opener machine, as is known in the art, which generally consists of counter rotating drums with teeth, which opens the fibers to produce what is sometimes referred to as “blown wool”. The short-staple fibers are then mixed with a second fill material, such as down, as described herein. In yet another embodiment, the short-staple fibers are loosely intertwined such that they resemble blown polyester or a down cluster. In various embodiments, the intertwined fibers are optionally formed from fibers which have been opened, as described, while in other embodiments, the fibers are not opened. The intertwined short-staple wool fibers are then mixed a second fill material, such as down, as described herein. In one embodiment, the short-staple wool fibers have a length of 12 mm, 32 mm, and/or 64 mm.

In yet another embodiment, the wool is batted or carded using a carding machine, as is known in the art. During the carding process, the second fill material, such as down, is also added to the carding machine. The resultant batting, as is known in the art, is a fill material that has been bonded together in some fashion, such as by a melting process, a chemical spray, or an intrinsic property of the fill materials. As is known in the art, a standard “carding” machine or a “bonding line” may be used where fibers are intertwined and combined into a substantially singular piece of material, where the individual materials are generally no longer loose. In one embodiment, the resultant carded material comprises about 60% or more wool and about 40% or less of down. Without being held to a single theory, the introduction of the second fill material, such as down, during the wool carding process causes the down to be ‘trapped’ between layers of wool, thus holding the down in place.

The wool fibers can be what is generically referred to as wool, Merino wool, or any other type and/or grade of wool, such as coarse wool (36+microns), downs (23-34 microns), medium (32-35 microns), fine crossbred (27-31 microns), comeback (21-26 microns), merino (less than 23 microns). In one embodiment, the wool is a wool blend as is known in the art, and includes such wool blends as wool/rayon, wool/bamboo, wool/tencel, wool/cotton, as well as a blend of grades of wool. Throughout the present description, the term wool will be used generically as including any type and/or grade of wool, as well as wool blends.

In various embodiments, prior to the wool being processed into clusters, the wool fibers are descaled, cleaned, and sterilized, as is known in the art, and cut to length. In various embodiments, the length of the wool fibers range from about 3 mm to about 64 mm in cut length.

In various embodiments, the wool fibers are treated to increase the washability of the fibers. In embodiment, the wool fiber is treated before being formed into clusters or intertwined fibers, as described above. In various embodiments, the wool treatment involves surface modification of the wool fibers to achieve desired properties. In one embodiment, the wool fibers are treated by a process known as Hercosett. In general, Hercosett treatment involves subjecting the wool to surface specific treatment using the chlorine Hercosett process, which renders the wool fiber shrink-resistant. In one embodiment, the process uses chlorine gas generated in situ from sodium hypochlorite and sulphuric acid or chlorine gas dissolved in water. The treatment is surface specific because the reaction with the wool fiber or cuticle takes place in less than 10 seconds, generally. The chlorination increases the surface energy of the cuticle so that Hercosett 125, a polyamide epichlorhydrin type polymer, which is then applied, can spread evenly along the fiber surface. This polymer swells to about 10 times its normal thickness in water, thus preventing the scale edges of adjacent fibers from interacting and causing felting during washing. The process is typically carried out in a modified backwasher. As is known in the art, other polymers and/or processes may be used to treat and/or coat the surface of the wool fibers, including silicone treatment. The result of this surface treatment provides for a washable wool, which creates a superior product. In various embodiments, the wool fibers may be treated using a water resistant technology, known in the art. In various embodiments, the wool may be treated with a chemical softener that traditionally has been used for cotton for softness, as is known in the art.

After the wool has been processed as described above, the wool is then blended with a secondary fill material, using methods known in the art, to result in the wool mixture fill material. In one embodiment, the secondary fill material is down, down/feather, feather, or other fibrous material such as bamboo, polyester, tencel, milk fiber, etc., or combinations thereof, to create a washable product that exhibits beneficial properties which are greater than the properties exhibited by wool fibers alone. For instance, blending the wool with these secondary fibers helps regulate temperature, increase breathability, etc.

In various embodiments, the inventors have determined that the blending ratio of the wool and secondary fill material is an important component to achieving the desired properties of the final product. In one embodiment, the wool represents less than 51% of the mixture. In one embodiment, the wool mixture fill material comprises 50% wool and 50% secondary fill material. In some embodiments, the wool can represent a higher percentage of the final mixture, however, the end “hand feel” of the product begins to degrade after 51%, under some circumstances. In one embodiment, to take advantage of the wool's properties, the wool percentage should be at least 15% of the total mixture. However, depending on final end use of the described mixture, the percentage of wool can represent less than 15% of the mixture. In one embodiment, the percentage of wool in the resultant mixture is from about 1% to about 99% and the percentage of the secondary fill material is from about 99% to about 1%. In one embodiment, when clusterized wool is used, the clusterized wool represents about 50% or less of the final mixture. In another embodiment, when staple wool is used, the staple wool represents about 80% or less of the final mixture.

In one embodiment, the described wool fibers are combined with down. Down, which grows next to the body of a goose or duck and beneath the feathers, is the well know soft fluffy fiber undercoating that traps the body's natural warmth. Down is used in a multitude of products, including pillows, comforters, bedding, jackets, and so on. Down provides a superior level of comfort and warmth as compared to most other natural and synthetic fibers. In particular, down is an excellent fiber for wicking away moisture while retaining body warmth. Even so, improvements to down, such as increased washability, are provided by the presently described mixture.

In various embodiments, the down is prepared by first sorting the original waterfowl plumage. As is known, plumage from waterfowl is a combination of down, feathers, fibers, and residue. These components are separated using any known sorting process. For example, since each of these components is different in weight and structure, a sorting machine using air chambers is able to separate the various components by weight. In one embodiment, only the down component is utilized in the described wool mixture fill material. In another embodiment, the feathers or down/feathers are used in the described wool mixture fill material. Next, in one embodiment, the down is washed so that dirt, dust and impurities are removed. During the washing process, the down goes through a washing production line that includes a feeding silo, where the material loading and loosening occurs. Washing then occurs by use of known washing machines. This may include a stainless steel drum with variable speed drive perforated screen and continual rinse and drainage capability. A discharging silo is then utilized to hold the wet and washed material and to regulate the amount of washed material that is fed to the dryer, generally a steam pressure vessel with a ventilated opening to trap excess dust and fiber. Once dried, the down is supplied to a cooler/deduster, which generally is a screen steel drum that agitates the down to release any remaining residue and, further, cools the down. In one embodiment, the down is subjected to a sterilization process, as is known in the art. In various embodiments, the down may additionally be treated using a water resistant technology, known in the art.

In one embodiment, the wool mixture fill material is formed by adding the desired amount of wool and secondary fill material, such as down, to a mixing box, where the wool and secondary fill material are blended by rotating arms within the mixing box which comb through and intimately mix the fill materials. In another embodiment, the wool mixture fill material is formed by adding the desired amount of wool and secondary fill material, such as down, to a blending box comprising a series of non-destructive paddles. The blending box method may further comprise conveyors for transporting the fill materials to a holding chamber which measures the amount of the wool and the secondary fill materials and once the desired amount is reached, drops the fill materials into the blending box, where the fill materials are blended via the series of non-destructive paddles. The use of the blending box has been found by the current inventor to be efficient and result in a consistent blend of fill materials. In various embodiments, following blending or mixing, the resultant mixture can either be blown directly into a product or into bags for holding in the future.

In one embodiment, the described wool mixture fill material comprises wool clusters, with the mixture having optimum performance due to one or more of i) a consistent blend; ii) the wool being de-scaled/de-scoured (a process well understood in the wool industry); iii) the wool being treated with a chemical softener, such as those traditionally used for cotton; and iv) consistent wool cluster size, such that the size of all the wool clusters is substantially similar. Depending on the particular embodiment, substantially similar means the wool cluster size varies by less than 1%, by less than 5%, by less than 10%, by less than 20%, or by less than 50% in a particular mixture. Upon production of the described wool mixture fill material, various products may be manufactured with the described fill. In particular, bedding, pillows, comforters, coats, and the like are filled with the inventive fill material to produce products that have the characteristics and qualities mentioned above. Since it is within the knowledge of those of ordinary skill in the art to produce pillows, comforters, etc., a description thereof is not provided herein. However, such products being filled with the wool mixture fill material are incorporated within the invention described herein.

What is claimed is:

1. A fill material comprising wool fiber clusters and a secondary fill material selected from the group consisting of down, down/feather, feather, a fibrous material, and combinations thereof.

2. The fill material of claim 1 wherein the fibrous material is selected from the group consisting of bamboo, polyester, tencel, milk fiber, and combinations thereof.

3. The fill material of claim 1 wherein the wool fiber clusters range in size from 0.5 mm to 20 mm.

4. The fill material of claim 1 wherein the wool fiber clusters are devoid, or substantially devoid, of individual fibers protruding from the cluster.

5. The fill material of claim 1 wherein the wool fiber clusters and the secondary fill material are substantially non-entangled.

6. The fill material of claim 1 wherein the wool fiber is coarse wool, downs wool, medium wool, fine crossbred wool, comeback wool, merino wool, or a wool blend.

7. The fill material of claim 6 wherein the wool blend is a wool/rayon blend, wool/bamboo blend, wool/tencel blend, wool/cotton blend, and/or a blend of grades of wool.

8. The fill material of claim 1 wherein the length of the wool fibers of the wool fiber cluster are in the range from 3 mm to 64 mm in cut length.

9. The fill material of claim 1 wherein wool fiber which forms the wool fiber cluster has been surface treated.

10. The fill material of claim 9 wherein the surface treatment is at least one of Hercosett or silicon treatment.

11. The fill material of claim 9 wherein the wool fiber which forms the wool fiber cluster has been treated with a chemical softener.

12. The fill material of claim 1 wherein the fill material comprises between 15% and 50%, inclusive, by weight, wool fiber cluster.

13. The fill material of claim 12 wherein the fill material comprises 50% by weight wool fiber clusters.

14. An article comprising the fill material of claim 1.

15. The article of claim 14 wherein the article is selected from the group consisting of pillow, comforter, throws, blankets, fiberbeds, featherbeds, apparel, sleeping bags, camping gear, and outerwear.

16. A fill material comprising batted wool fiber and a secondary fill material selected from the group consisting of down, down/feather, feather, a fibrous material, and combinations thereof.

17. The fill material of claim 16 wherein the batted fill material comprises about 60% or more wool and about 40% or less of down.

18. A method of forming a wool mixture fill material, the method comprising
combining wool fiber clusters and a secondary fill material selected from the group consisting of down, down/feather, feather, a fibrous material, and combinations thereof, wherein the combining occurs by at least one of a mixing box or a blending box.

19. The method of claim 18 wherein the wool fiber clusters range in size from 0.5 mm to 20 mm.

20. The method of claim 18 wherein the wool fiber clusters are devoid, or substantially devoid, of individual fibers protruding from the cluster.
